(19) United States
(12) Patent Application Publication
(10) Pub. No.: US 2024/0004952 A1
(43) Pub. Date: Jan. 4, 2024

(54) Hardware-Aware Mixed-Precision Quantization

(71) Applicant: MediaTek Singapore Pte. Ltd., Singapore (SG)

(72) Inventors: Hantao Huang, Singapore (SG); Ziang Yang, Singapore (SG); Jia Yao Christopher Lim, Singapore (SG); Jung Hau Foo, Singapore (SG); Chia-Lin Yu, Hsinchu City (TW)

(21) Appl. No.: 17/852,484

(22) Filed: Jun. 29, 2022

(51) Int. Cl. G06F 17/15; G06F 7/544; G06N 3/02

(52) U.S. Cl. CPC G06F 17/15; G06F 7/5443; G06N 3/02

(57) ABSTRACT

A bit-widths determination method selects bit-widths for mixed-precision neural network computing on a target hardware platform. An activation quantization sensitivity (AQS) value is calculated for each convolution layer in a neural network. The AQS value indicates the sensitivity of convolution output to quantized convolution input. One or more convolution layers are grouped into a quantization group, which is to be executed by a corresponding set of target hardware. A group AQS value is calculated for each quantization group based on the AQS values of the convolution layers in the quantization group. Then bit-widths supported by the target hardware platform are selected for the corresponding quantization groups. The bit-widths are selected to optimize, under a given constraint, a sensitivity metric that is calculated based on each quantization group's group AQS value.

### TECHNICAL FIELD

Embodiments of the invention relate to a mixed-precision neural network that optimizes quantization sensitivity when executed on a target hardware platform.

### BACKGROUND

Neural network computing is computation-intensive and bandwidth-demanding. Modern computers typically use floating-point numbers with a large bit-width (e.g., 32 bits) in numerical computations for high accuracy. However, the high accuracy is achieved at the cost of high power consumption and high memory usage. With the rapid advance in neural networks, the size of a typical neural network model has become larger and hardware requirements have become more stringent. It is a challenge to balance the need for low power consumption and low memory usage while maintaining an acceptable accuracy in neural network computing.

Quantization is a main optimization method for model compression. A low bit-width neural network consumes less power, runs faster, and uses less memory compared to a high bit-width neural network. Although a low bit-width neural network may perform well for vision perception problems (e.g., image recognition), it may fail to meet the required performance for vision construction (image segmentation) and vision quality problems (image super-resolution).

Therefore, there is a need for improving the quantization of neural networks for execution on a target hardware platform.

### SUMMARY

In one embodiment, a method is provided for determining the bit-widths for mixed-precision neural network computing on a target hardware platform. The method comprises the step of calculating an activation quantization sensitivity (AQS) value for each convolution layer in a neural network. The AQS value indicates the sensitivity of convolution output to quantized convolution input. The method further comprises the steps of forming quantization groups by grouping one or more convolution layers into a quantization group to be executed by a corresponding set of target hardware; calculating a group AQS value for each quantization group based on AQS values of the convolution layers in the quantization group; and selecting bit-widths supported by the target hardware platform for corresponding quantization groups. The bit-widths are selected to optimize, under a given constraint, a sensitivity metric that is calculated based on each quantization group's group AQS value.

In another embodiment, a system is provided to determine the bit-widths for mixed-precision neural network computing on a target hardware platform. The system comprises memory to store a neural network and processing circuitry coupled to the memory. The processing circuitry is operative to calculate an AQS value for each convolution layer in the neural network. The AQS value indicates the sensitivity of convolution output to quantized convolution input. The processing circuitry is further operative to form quantization groups by grouping one or more convolution layers into a quantization group to be executed by a corresponding set of target hardware; calculate a group AQS value for each quantization group based on AQS values of the convolution layers in the quantization group; and select bit-widths supported by the target hardware platform for corresponding quantization groups. The bit-widths are selected to optimize, under a given constraint, a sensitivity metric that is calculated based on each quantization group's group AQS value.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating the calculation of AQS according to one embodiment.

FIG. 2A is a diagram illustrating AQS computation according to one embodiment.

FIG. 2B is a diagram illustrating AQS computation according to another embodiment.

FIG. 3 illustrates an example of quantization group formation according to one embodiment.

FIG. 4A illustrates a process for AQS computation and group AQS computation according to one embodiment.

FIG. 4B illustrates a process for AQS computation and group AQS computation according to another embodiment.

FIG. 5A illustrates a process for offline mix-precision optimization according to one embodiment.

FIG. 5B illustrates a process for offline mix-precision optimization according to another embodiment.

FIG. 6 is a diagram illustrating a process for data precision search according to one embodiment.

FIG. 7 is a flow diagram illustrating a method for determining bit-widths for mixed-precision neural network computing on a given hardware platform according to one embodiment.

FIG. 8 is a diagram illustrating a system operative to determine bit-widths for mixed-precision neural network computing on a given hardware platform according to one embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a system and method for determining the bit-widths of operands in a neural network with an objective to minimize a sensitivity metric subject to hardware and/or performance constraints. The operands, also referred to as quantizer targets, are input operands (including input activation and weights) and/or output operands of operation layers (“OP layers”) in a neural network. The sensitivity metric is calculated from activation quantization sensitivity (AQS). An AQS value indicates the sensitivity of convolution output to quantized convolution input and weights. The AQS values are measured in a learning process. The resulting bit-width configuration of the neural network is a mixed-precision quantization configuration; that is, different OP layers of the neural network may be configured with different bit-widths. One or more OP layers may form a quantization group. For example, multiple convolution layers may form one quantization group, such that they are configured with the same bit-width for their input activations and the same bit-width for their weights. The bit-widths are selected from the bit-widths supported by the target hardware. For example, the supported bit-widths on the target hardware for convolution may include w4a4, w8a8, w16a16, etc., where w and a indicate weight and input activation, respectively, and the numbers following w and a indicate the bit-widths of weight and input activation, respectively. In some embodiments, the target hardware may support convolutions where w and a have different bit-widths, such as w8a4, w16a8, etc.

As disclosed herein, the terms “bit-width” and “data precision” are used interchangeably. Furthermore, the terms “neural network” and “neural network model” are used interchangeably.

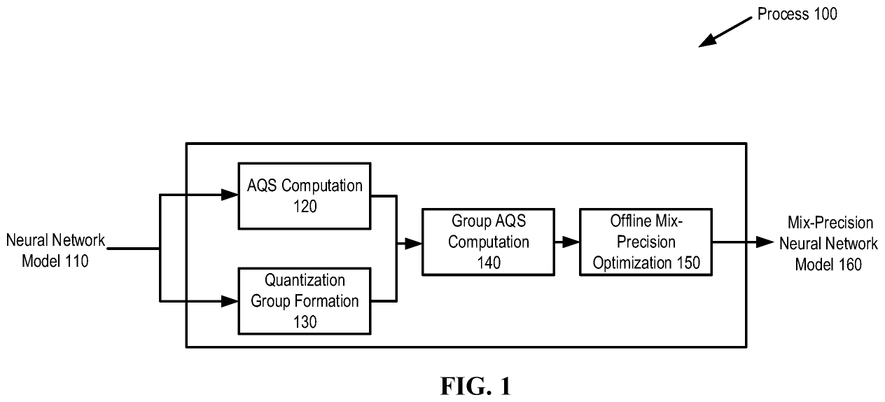

FIG. 1 is a diagram illustrating an overview of a mixed-precision quantization process 100 performed on a neural network model according to one embodiment. The process 100 receives a neural network model 110 as input. The neural network model 110 is a deep neural network (DNN) that includes multiple operation layers (i.e., OP layers). The neural network model 110 may define some or all of its operations in a floating-point data format (e.g., 32-bit floating-point) or another high-precision data format. Process 100 transforms the data format defined in the neural network model 110 into a quantized mix-precision data format and outputs a mix-precision neural network model 160.

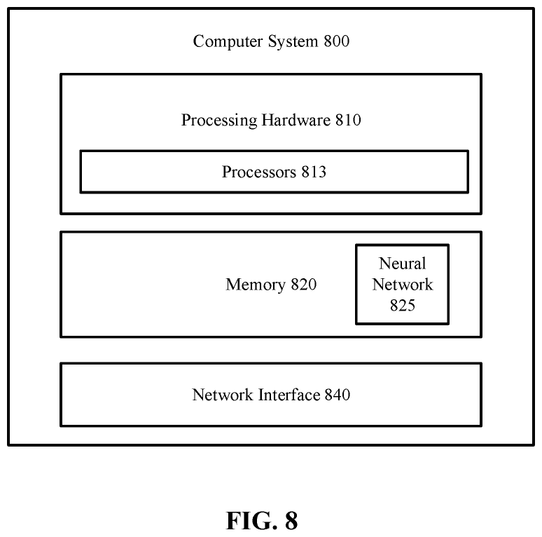

In one embodiment, process 100 includes the following operations: AQS computation 120, quantization group formation 130, group AQS computation 140, and offline mix-precision optimization 150. In one embodiment, the process 100 may be performed by a computer system, such as a computer system 800 in FIG. 8. In one embodiment, the AQS computation 120 computes an AQS value for each convolution layer (i.e., the “per-layer AQS value”). The AQS value measures the Euclidean distance of convolution output fluctuation induced by weight quantization. The quantization group formation 130 groups one or more OP layers into a quantization group within which no re-quantization operations are performed during neural network training and inference. The group AQS computation 140 computes a group AQS value for each quantization group. The offline mix-precision optimization 150 determines the bit-width(s) of the quantizer targets in each quantization group by optimizing a sensitivity metric for the entire neural network model. The optimization 150 is performed offline. The mix-precision neural network model 160 output from process 100 includes a bit-width configuration for each OP layer. The mix-precision neural network model 160 performs the same operations as the input neural network model 110, but the operations may be in different bit-widths. Subsequently, the mix-precision neural network model 160 is trained according to the bit-width configuration, and the trained mix-precision neural network model 160 is used for inference operations.

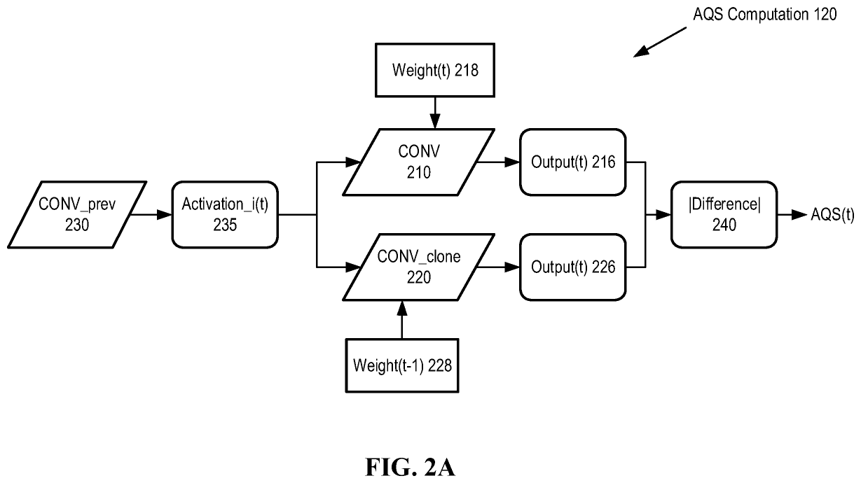

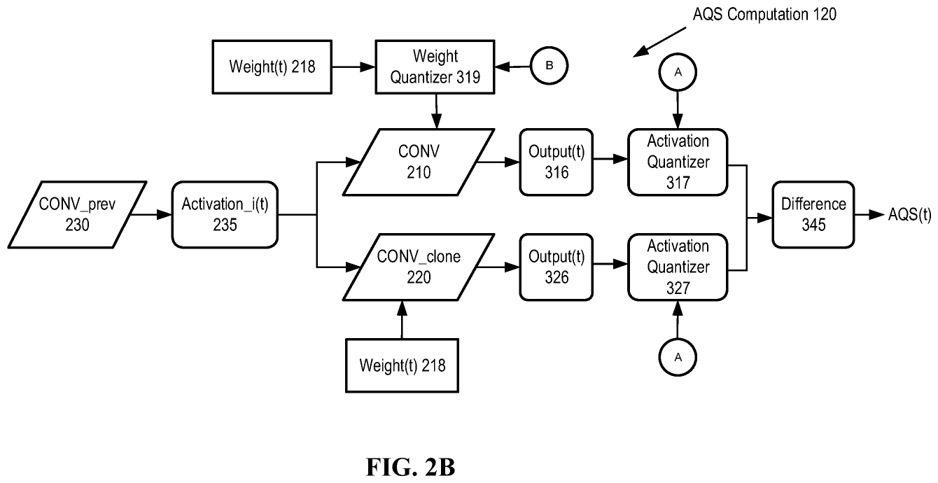

FIG. 2A is a diagram illustrating the AQS computation 120 according to one embodiment. The OP layer illustrated in this example is a convolution layer (e.g., CONV 210). Activation_i(t) 235, which is the output from a previous convolution layer (CONV_prev 230), represents the input activation to CONV 210 at step(t). Output(t) 216 and Output(t) 226 represent the outputs from CONV 210 and CONV_clone 220, respectively. CONV_clone 220 represents an identical copy of CONV 210. CONV 210 applies weight(t) 218 to Activation_i(t) 235 to generate Output(t) 216, where weight(t) 218 represents the convolutional weights at step(t). The same CONV 210 or CONV clone 220 applies weight(t−1) 228 to Activation_i(t) 235 to generate Output(t) 226, where weight(t−1) 228 represents the convolutional weights at step(t−1). The cloned version CONV_clone 220 may be used to enable parallel computations of Output(t) 216 and Output(t) 226. The same bit-width is used for all of weight(t) 218, weight(t−1) 228, CONV_prev 230, Output(t) 216, and Output(t) 226, and is fixed during the entire sampling period t=1, . . . T.

CONV 210 and CONV_clone 220 perform the same convolution operations on the same input Activation_i(t) 235. However, CONV 210 and CONV_clone 220 use weights that differ by one step. A step is between two consecutive samples; e.g., weights(t−1) may be updated to weights(t) by backward propagation between steps (t−1) and t. The absolute value of the difference (e.g., |Difference| 240) between Output(t) 216 and Output(t) 226 provides an indication of quantization sensitivity of CONV 210.

In one embodiment, the AQS computation 120 may be performed in the late stage of the sampling period when initial weights fluctuation is expected to settle down. As a non-limiting example, if the sampling is performed for 100 steps, the AQS computation 120 may be performed in the last 20 steps. The |Difference| 240 computed in the last 20 steps may be averaged to produce an AQS value for the convolution layer CONV 210. A large |Difference| 240 indicates that the weights may not be converging as expected, and the lack of convergence may be caused by quantization.

According to the example in FIG. 2A, the per-layer AQS value may be calculated in the following steps. A first output of a convolution layer is calculated using input activation and weights at step (t). A second output of the convolution layer is calculated using the input activation and the weights at step (t−1). Then the difference between the first output and the second output is measured. The difference is used to compute the AQS value of the convolution layer.

FIG. 2B is a diagram illustrating the AQS computation 120 according to another embodiment. The same CONV 210 and CONV_clone 220 are used in this example, and both CONV 210 and CONV_clone 220 use the same weight(t) 218. However, CONV 210 applies a weight quantizer 319 with data precision B to Activation_i(t) 235. Activation quantizers 316 and 317 quantize convolution outputs Output(t) 316 and Output(t) 326, respectively, into data precision A, where data precision A has a larger bit-width than data precision B. A difference 345 is computed between Output(t) 316 and Output(t) 326, where the difference may be any difference measurement such as the maximum absolute error (MAE), the Kullback-Leibler divergence (KLD), etc.

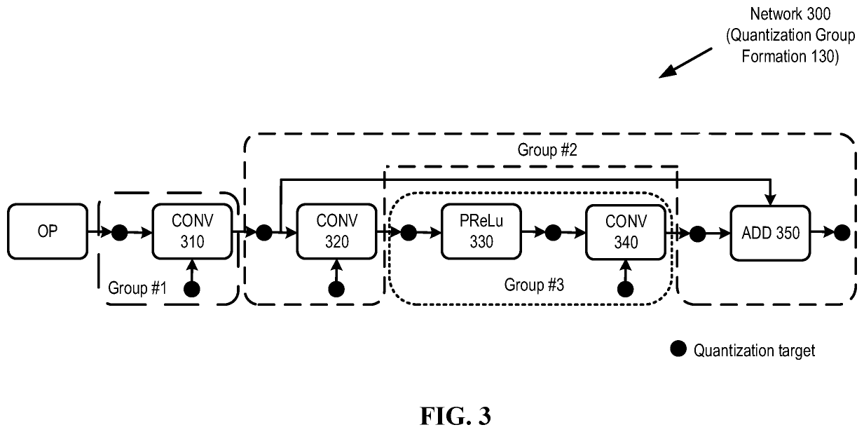

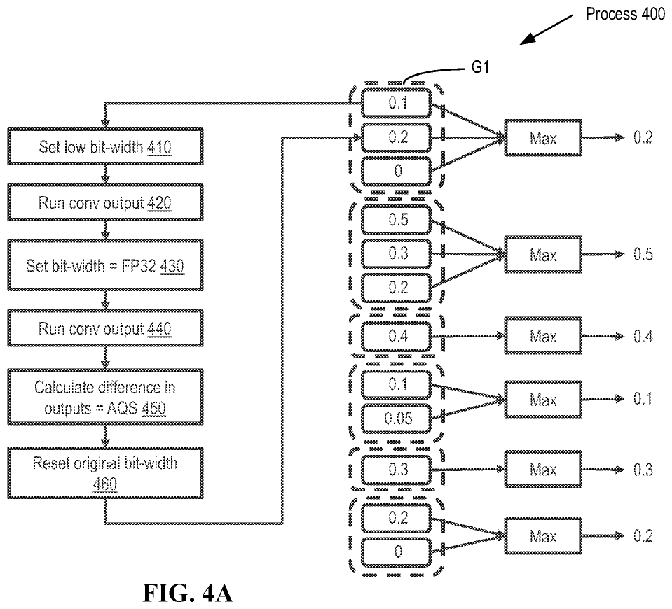

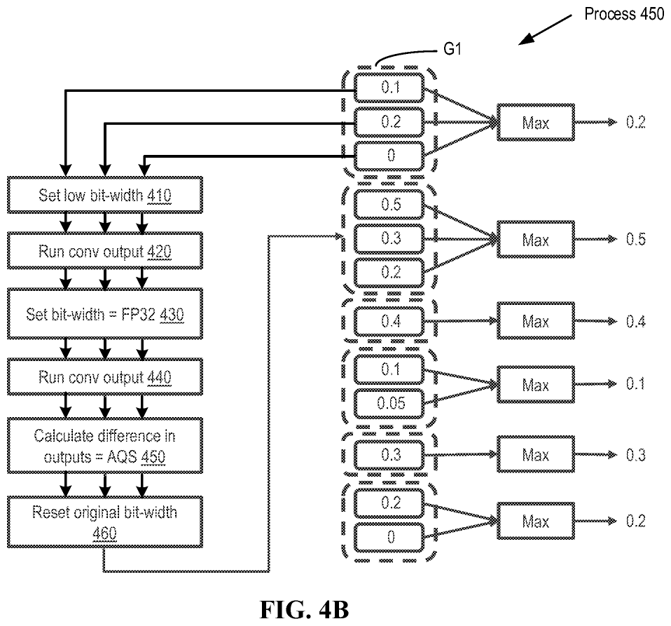

When performing mixed-precision quantization, multiple quantizer targets may be grouped together. A quantizer target may be the input activation, weights, and/or output of an OP layer. It can be understood that a quantization group is formed by grouping one or more OP layers. This grouping mechanism forces the quantizer targets of the same type (e.g., activation type or the weight type) to have the same precision setting (i.e., the same bit-width). The same bit-width is used in the same quantization group; thus, no re-quantization is needed for operations performed within a quantization group on the target hardware. Different quantization groups may have different precision settings (i.e., different bit-widths). The grouping result is recorded in a quantization configuration file, and users can set the precision search space on each of the quantization groups. In the following description with reference to FIGS. 3, 4A, and 4B, for simplicity, the description focuses on an example where the target hardware supports the same bit-width for input activation and weights in each quantization group. However, it should be understood that such an example is non-limiting and the methods and processes described herein apply to target hardware that supports, for each quantization group, an input activation bit-width and a weight bit-width that are different from each other.

FIG. 3 illustrates an example of the quantization group formation 130 according to one embodiment. A neural network may be described by a graph. The graph can be divided into multiple quantization groups based on the network structure and the relationship among the inputs of OP layers. OP layers that share the same input activation may be grouped into the same quantization group. Group formation is depending on the available hardware on which the OP layers are executed.

In one embodiment, the target hardware for convolution may perform convolution of input activation and weights in one bit-width and generate an output in the same or another bit-width. Thus, a quantization group formed by a given convolution layer includes the convolution's input activation and weights, and the convolution's output may belong to another quantization group. In one embodiment, the target hardware supports an ADD OP layer with input operands and output operands having the same bit-width. Thus, the ADD's input operands and output operands belong to the same quantization group. The target hardware also supports PreLu with input operands and output operands having the same bit-width. Thus, PreLu's input operands and output operands belong to the same quantization group.

The network graph 300 in FIG. 3 includes five OP layers: a first convolution layer (CONV 310), a second convolution layer (CONV 320), a PreLU layer (PreLU 330), a third convolution layer (CONV 340), and an add layer (ADD 350). The black circles represent quantizer targets, such as input activations and weights.

In this example, the target hardware supports a convolution layer that receives input activation and weights in a first data precision and generates an output in a second data precision. For example, the first data precision may be 4-bit fixed-point and the second data precision may be 8-bit fixed-point. Thus, for each of CONV 310, CONV 320, and CONV 340, the corresponding input activation and the corresponding weights form one quantization group. A quantization group may be extended to include additional input and/or output of one or more other OP layers, such as PreLu, add, etc.

As shown in FIG. 3, group #1 includes the input operands (i.e., the input activation and weights) of CONV 310, and group #2 includes the input operands of CONV 320. However, since the input activation of CONV 320 is also an input operand of ADD 350, group #2 can be extended to include both input operands of ADD 350, as both input operands of an add must have the same bit-width to avoid re-quantization. In a scenario where the hardware adder supports the same data precision for input and output, group #2 is further extended to include the output operand of ADD 350. The input operands of CONV 340 form group #3. Since the input activation of CONV 340 is the output of PreLu 330, and the target hardware supports the same data precision for the input and output of PreLu, group #3 is extended to include the input of PreLu 330. Thus, three quantization groups are formed in the example in FIG. 3.

After the AQS computation 120 and the quantization group formation 130, a group AQS value is computed for each quantization group. When a quantization group includes a single convolution layer, the AQS value of that convolution layer is the group AQS value. When a quantization group includes multiple convolution layers, the maximum, mean, average, or another representative metric of those convolution layers' AQS values is the group AQS value.

In one embodiment, the per-layer AQS value may be computed based on the difference in the convolution outputs between a low bit-width setting (e.g., 4-bit or 8-bit fixed point) and a high bit-width setting (e.g., 32-bit floating point). FIGS. 4A and 4B illustrate group AQS computations that use alternative methods for computing the per-layer AQS value and the corresponding group AQS value.

FIG. 4A illustrates a process 400 for the group AQS computation 140 according to one embodiment. An example of the per-layer AQS computation is shown in steps 410-460 on the left-hand side. An example of a corresponding group AQS computation based on the per-layer AQS values is shown on the right-hand side. The numerical values in the blocks with solid outlines represent per-layer AQS values, and the blocks with dashed outlines represent a quantization group. Before the per-layer AQS computation, the convolution layer may originally be configured at a given bit-width (“original bit-width”). Steps 410-460 are performed on each convolution layer in each group sequentially. Starting from quantization group G1, at step 410, the input activation and the weights of a convolution layer are set to a low bit-width; e.g., a fixed-point data precision supported by the target hardware such as 4-bit fixed-point numbers. The convolution layer at step 420 generates a first output from the low bit-width input operands. At step 430, the input activation and the weights of the convolution layer are set to a high bit-width; e.g., a floating-point data precision supported by the target hardware such as 32-bit floating-point numbers. The convolution layer at step 440 generates a second output from the high bit-width operands. At step 450, the difference between the first output and the second output is calculated as the per-layer AQS value of the convolution layer. At step 460, the input activation and the weights of the convolution layer are set to the original bit-width. Process 400 then repeats steps 410-460 to determine the per-layer AQS value for the next convolution layer in group G1. A group AQS is determined after steps 410-460 apply to each of the three layers in G1, layer-by-layer.

In this non-limiting example, process 400 sets the group AQS value as the maximum per-layer AQS value among all the per-layer AQSs in the same quantization group. It is understood that a mean, an average, or another representative metric may be used in place of the maximum value in alternative embodiments.

FIG. 4B illustrates a process 450 for the group AQS computation 140 according to another embodiment. According to process 450, at each step, all layers in the same quantization group are set to the same bit-width. For example at step 410, all three layers in group G1 are set to the same low bit-width, and at step 420, all three layers in group G1 perform respective convolutions to obtain respective outputs. The operations at step 420 may be performed layer-by-layer. At step 430, all three layers in group G1 are set to the same bit-width of 32-bit floating-point. The operations at steps 440 and 450 may be performed layer-by-layer to obtain the per-layer AQS value for each of the three layers. At step 460, all three layers in group G1 are set to the original bit-width. In this non-limiting example, the group AQS value is the maximum per-layer AQS value among all AQSs in the same quantization group. It is understood that a mean, an average, or another representative metric may be used in place of the maximum value in alternative embodiments. Process 450 then proceeds to the next quantization group to repeat steps 410-460.

According to FIGS. 4A and 4B, the per-layer AQS value may be calculated in the following steps. A first output of a convolution layer is calculated using input activation and weights at a predetermined fixed-point data precision. A second output of the convolution layer is calculated using the input activation and the weights at a predetermined floating-point data precision. Then the difference between the first output and the second output is measured. The difference is used to compute the AQS value of the convolution layer.

After the group AQS values are computed for all quantization groups in the neural network, a mixed-precision optimization process is performed to determine the bit-width(s) of each quantization group. Different bit-widths may be chosen for different quantization groups. The bit-widths are chosen to minimize the quantization sensitivity of the neural network. An objective of the sensitivity minimization is to minimize the change or fluctuation in neural network output when quantization errors are present. When supported by the target hardware, in some embodiments the mixed-precision optimization process may select an input activation bit-width and a weight bit-width for each quantization group, where the input activation bit-width is different from the weight bit-width.

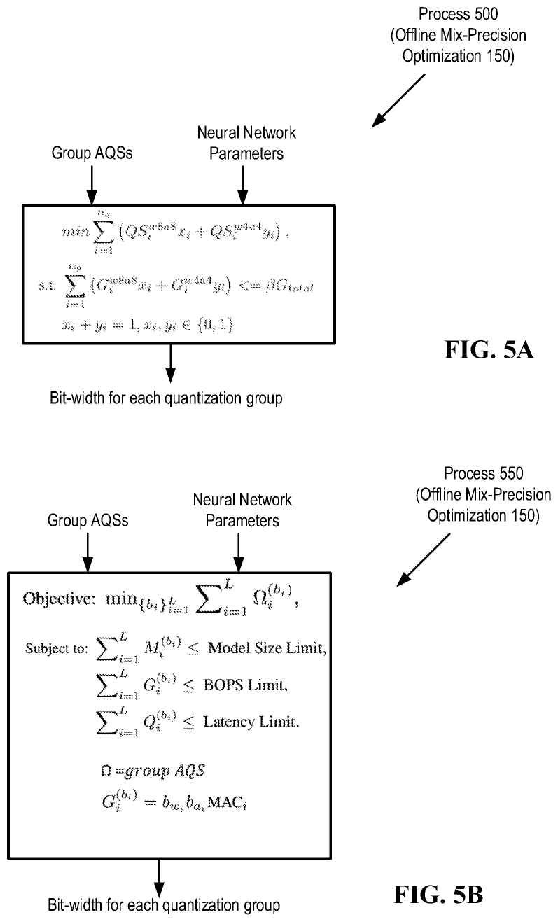

FIG. 5A illustrates a process 500 for the offline mix-precision optimization 150 according to one embodiment. Process 500 may be performed by a computer system offline after AQS values and group AQS values of a neural network are computed. Process 500 receives the group AQS values and neural network parameters (e.g., activation size, filter size, etc.), and generates a chosen bit-width for quantizer targets of the same type (e.g., activation type a or weight type w) in each quantization group. A mathematical formulation of process 500 is shown in FIG. 5A.

In this embodiment, the optimization objective is to minimize the sum of quantization sensitivity (QS) across all quantization groups (n_{g}) under the constraints of multiply-and-add (MAC) reduction and binary selections. The quantization sensitivity (QS) is calculated for each quantization group as: QS=group AQS/α, where α is a factor determined based on bit-width; e.g., a bit-width multiplied by the number of parameters or multiplied by the number of MAC operations in the quantization group. In this example, the optimization is to choose a bit-width between w8a8 (8 bits) or w4a4 (4 bits) for weights (w) and input activation (a). The optimization formulation of process 500 further includes an adjustable parameter β, the number of quantization groups n_{g}, and variables xᵢ, yᵢ, that indicate whether 8 bits or 4 bits is selected for the bit-width for the i-th quantization group. In this example, the constraint is that the total number of binary operations (BOPS) is less than βGₜₒₜₐₗ. The total BOPS constraint limits the sum of per-group BOPS, where the per-group BOPS Gᵢ is calculated as Gᵢ^{(bi)}=b_{w}_{ᵢ}bₐ_{ᵢ}MACᵢ, where MACᵢ is the number of MAC operations in the i-th quantization group, and b_{w}_{ᵢ}bₐ_{ᵢ} may be 4×4 when w4a4 is chosen (i.e., α=w=4 bits) or 8×8 when w8a8 is chosen (i.e., a=w=8 bits) is chosen in this example.

FIG. 5B illustrates a process 550 for the offline mix-precision optimization 150 according to another embodiment. Process 550 may be performed by a computer system offline after AQS values and group AQS values of a neural network are computed. Similar to process 500 in FIG. 5A, process 550 receives the group AQS values and neural network parameters, and generates a chosen bit-width for quantizer targets of the same type (e.g., activation type a or weight type w) in each quantization group. A mathematical formulation of process 550 is shown in FIG, 5B. In one embodiment, the optimization may be formulated as an Integer Linear Programming (ILP) problem and can be solved by known ILP methods.

In this embodiment, the ILP optimization objective is to obtain a mixed-precision quantization configuration that minimizes a total AQS under a given constraint. The total AQS is the sum of all group AQS values across all quantization groups (L) in the neural network. The group AQS value is shown in FIG. 5B as quantization sensitivity (Ω). The given constraint in FIG. 5B is the total BOPS constraint, which limits the sum of per-group BOPS where the per-group BOPS is calculated as Gᵢ^{(bi)}=b_{w}bₐ_{ⱼ} MACᵢ as mentioned above in process 500 of FIG. 5A. Alternatively or additionally, constraints such as model size limit and/or latency limit may be used. The model size is proportional to the number of weights and the bit-width of each weight in the neural network, and the latency is the elapsed time between an input fed into the neural network and the output generated by the neural network.

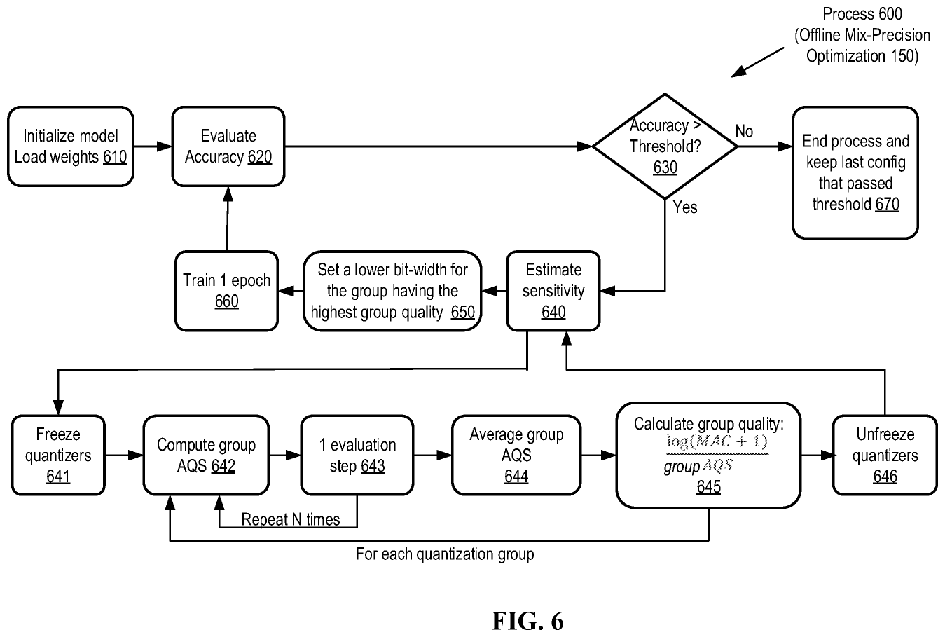

FIG. 6 is a diagram illustrating a process 600 for the offline mix-precision optimization 150 according to yet another embodiment. Process 600 may be performed by a computer system, such as a computer system 800 in FIG. 8. In this embodiment, the data precision search is a greedy search. The output of the search is a mixed-precision bit-width configuration of a neural network. At step 610, a neural network model is initialized and the weights of an original bit-width for convolution operations are loaded into the system. The weights may have the same bit-width across all convolution layers. The data precision search may find a lower bit-width for at least some of the convolution layers. At step 620, the accuracy of the neural network is evaluated, where the accuracy may be a user-defined accuracy criterion. In one embodiment, the accuracy may be estimated by peak signal-to-noise (PSNR) calculated as 10 log₁₀(R²/MSE), where R is the maximum possible pixel value in the input image, and MSE is the mean square error between a noisy image output and the ground truth. Different accuracy metrics or criteria may be used for different neural network applications. If the accuracy is greater than a predetermined threshold at step 630, it is an indication that the bit-width for at least some of the convolution layers may be reduced.

Process 600 proceeds to estimate the sensitivity of the neural network at step 640 if the accuracy is greater than the threshold. Based on the estimated sensitivity of all quantization groups, process 600 at step 650 sets a lower bit-width for the quantization group that has the highest group quality. The neural network is sampled (i.e., generates an output) for one epoch at step 660. Process 600 returns to step 620 to evaluate the accuracy of the neural network output with the lower bit-width configured for the quantization group determined at step 650. If at step 630, the accuracy is not greater than the threshold, the neural network model keeps the quantization configuration that last passes the accuracy threshold and process 600 terminates.

At step 640, the quantization sensitivity of the neural network is estimated by the following steps. At step 641, the trainable parameters (e.g., minimum, maximum, etc.) of all quantizers are frozen . At step 642, the group AQS value of each quantization group is computed. As mentioned before, a group AQS value may be computed as the maximum or average of the AQS values of the convolution layers in a quantization group. AQS computation and group AQS computation have been described with reference to FIGS. 2, 4A, and 4B. At step 643, the neural network undergoes one evaluation step and process 600 returns to step 642. Steps 642 and 643 repeat N times (e.g., N=100), and the average of the N group AQS values is computed. At step 644, a group quality

$$\\ \frac{log ( MAC + 1 )}{group AQS}$$

is calculated for the quantization group. Steps 642-644 are repeated for each quantization group, at the end of which all quantizers are unfrozen. At step 650, the quantization group having the highest group quality is set to a lower bit-width supported by the target hardware. Process 600 continues until step 630 at which the accuracy is not greater than the threshold.

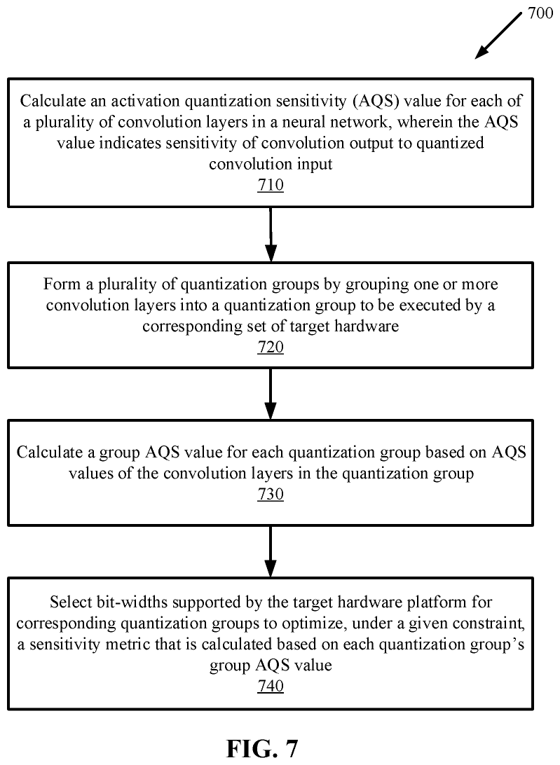

FIG. 7 is a flow diagram illustrating a method 700 for determining bit-widths for mixed-precision neural network computing on a given hardware platform according to one embodiment. Method 700 may be performed by a computer system, such as a computer system 800 in FIG. 8. However, it should be understood that the operations of the flow diagram of FIG. 7 can be performed by embodiments of the invention other than the embodiment of FIG. 8. Furthermore, it should be understood that alternative embodiments may perform the operations shown in FIG. 7 in a different order. In some alternative embodiments, certain operations shown in FIG. 7 may be combined and/or may overlap.

Method 700 begins with step 710 where the computer system calculates an AQS value for each convolution layer in a neural network. The AQS value indicates the sensitivity of convolution output to quantized convolution input. At step 720, quantization groups are formed by grouping one or more convolution layers into a quantization group to be executed by a corresponding set of target hardware. At step 730, the computer system calculates a group AQS value for the quantization group based on the AQS value of each convolution layer in the quantization group. At step 740, the computer system selects bit-widths supported by the target hardware platform for corresponding quantization groups to optimize, under a given constraint, a sensitivity metric that is calculated based on each quantization group's group AQS value.

Alternative optimization processes that may be performed in connection with step 740 have been described in connection with FIGS. 5A, 5B, and 6. In one embodiment, the computer system may select an input activation bit-width and a weight bit-width for each quantization group to optimize the sensitivity metric under the given constraint, where the input activation bit-width may be different from the weight bit-width.

FIG. 8 is a diagram illustrating a computer system 800 operative to determine bit-widths for mixed-precision neural network computing on a given hardware platform according to one embodiment. In one embodiment, the computer system 800 includes hardware circuits for executing the operations described in connection with FIGS. 1-7. The computer system 800 includes processing hardware 810. In one embodiment, the processing hardware 810 may include one or more processors 813, such as central processing units (CPUs), graphics processing units (GPUs), digital signal processing units (DSPs), artificial intelligence (AI) processors, neural processing units, and other general-purpose and/or special-purpose processing circuitry. Referring back to FIGS. 1-7, the one or more processors 813 may execute instructions stored in a memory 820 to perform operations described in connection with FIGS. 1-7.

The memory 820 is coupled to the processing hardware 810. The memory 820 may include dynamic random access memory (DRAM), SRAM, flash memory, and other non-transitory machine-readable storage media; e.g., volatile or non-volatile memory devices. The memory 820 may further include storage devices, for example, any type of solid-state or magnetic storage device. In one embodiment, the memory 820 may include a neural network 825, for which the processing hardware 810 performs mixed-precision quantization. In one embodiment, the memory 820 may store instructions which, when executed by the processing hardware 810, cause the processing hardware 810 to perform the aforementioned mixed-precision quantization, such as the method 700 in FIG. 7. In some embodiments, the system 800 may also include a network interface 840 to connect to a wired and/or wireless network for transmitting and/or receiving voice, digital data, and/or media signals. It is understood the embodiment of FIG. 8 is simplified for illustration purposes. Additional hardware components may be included.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for determining bit-widths for mixed-precision neural network computing on a target hardware platform, comprising:
calculating an activation quantization sensitivity (AQS) value for each of a plurality of convolution layers in a neural network, wherein the AQS value indicates sensitivity of convolution output to quantized convolution input;
forming a plurality of quantization groups by grouping one or more convolution layers into a quantization group to be executed by a corresponding set of target hardware;
calculating a group AQS value for each quantization group based on AQS values of the convolution layers in the quantization group;
selecting bit-widths supported by the target hardware platform for corresponding quantization groups to optimize, under a given constraint, a sensitivity metric that is calculated based on each quantization group's group AQS value.

2. The method of claim 1, further comprising:
performing Integer Linear Programming (ILP) to obtain a mixed-precision quantization configuration for the neural network that minimizes a total AQS under the given constraint, wherein the total AQS is a sum of all group AQS values in the neural network.

3. The method of claim 2, wherein the given constraint is one of a model size, latency, and total binary operations of the neural network.

4. The method of claim 1, wherein the given constraint is total binary operations (BOPS), which limits a sum of per-group BOPS, and wherein per-group BOPS is calculated as the number of MAC operations multiplied by the bit-width of input activation and the bit-width of weights.

5. The method of claim 1, further comprising:
selecting an input activation bit-width and a weight bit-width for each quantization group to optimize the sensitivity metric under the given constraint.

6. The method of claim 1, further comprising:
identifying one or more quantization groups to lower corresponding bit-widths under a user-defined accuracy criterion.

7. The method of claim 6, wherein an identified quantization group is one having a highest group quality
$$\\ \frac{log ( MAC + 1 )}{goup AQS}$$
among all quantization groups, wherein MAC represents a number of multiply-and-add operations.

8. The method of claim 1, wherein the group AQS value is the maximum AQS value of all convolution layers in the quantization group.

9. The method of claim 1, wherein calculating the AQS value further comprises:
calculating a first output of a convolution layer using input activation and weights at step t;
calculating a second output of the convolution layer using the input activation and the weights at step (t−1); and
measuring a difference between the first output and the second output to compute the AQS value of the convolution layer.

10. The method of claim 1, wherein calculating the AQS value further comprises:
calculating a first output of a convolution layer using input activation and weights at a first data precision;
calculating a second output of the convolution layer using the input activation and the weights at a second data precision, the second data precision using a larger bit-width than the first data precision; and
measuring a difference between the first output and the second output to compute the AQS value of the convolution layer.

11. The method of claim 1, wherein grouping the one or more convolution layers into the quantization group further comprises:
grouping operation (OP) layers that share a same input activation.

12. A system operative to determine bit-widths for mixed-precision neural network computing on a target hardware platform, comprising:
memory to store a neural network; and
processing circuitry coupled to the memory and operative to:
calculate an activation quantization sensitivity (AQS) value for each of a plurality of convolution layers in the neural network, wherein the AQS value indicates sensitivity of convolution output to quantized convolution input;
form a plurality of quantization groups by grouping one or more convolution layers into a quantization group to be executed by a corresponding set of target hardware;
calculate a group AQS value for each quantization group based on AQS values of the convolution layers in the quantization group; and
select bit-widths supported by the target hardware platform for corresponding quantization groups to optimize, under a given constraint, a sensitivity metric that is calculated based on each quantization group's group AQS value.

13. The system of claim 12, wherein the processing circuitry is further operative to:
perform Integer Linear Programming (ILP) to obtain the bit-width for each quantization group that optimizes a total AQS under the given constraint, wherein the total AQS is a sum of all group AQS values in the neural network.

14. The system of claim 12, the given constraint is total binary operations (BOPS), which limits a sum of per-group BOPS, and wherein per-group BOPS is calculated as the number of MAC operations multiplied by the bit-width of input activation and the bit-width of weights.

15. The system of claim 12, wherein the processing circuitry is further operative to:
select an input activation bit-width and a weight bit-width for each quantization group to optimize the sensitivity metric under the given constraint.

16. The system of claim 12, wherein the processing circuitry is further operative to:
identify one or more quantization groups to lower corresponding bit-widths under a user-defined accuracy criterion.

17. The system of claim 16, wherein an identified quantization group is one having a highest group quality
$$\\ \frac{log ( MAC + 1 )}{goup AQS}$$
among all quantization groups, wherein MAC represents a number of multiply-and-add operations.

18. The system of claim 12, wherein the group AQS value is the maximum AQS value of all convolution layers in the quantization group.

19. The system of claim 12, wherein the processing circuitry when calculating the AQS value is further operative to:
calculate a first output of a convolution layer using input activation and weights at step t;
calculate a second output of the convolution layer using the input activation and the weights at step (t−1); and
measure a difference between the first output and the second output to compute the AQS value of the convolution layer.

20. The system of claim 12, wherein the processing circuitry when calculating the AQS value is further operative to:
calculate a first output of a convolution layer using input activation and weights at a first data precision;
calculate a second output of the convolution layer using the input activation and the weights at a second data precision, the second data precision using a larger bit-width than the first data precision; and
measure a difference between the first output and the second output to compute the AQS value of the convolution layer.
